(19) United States
(12) Patent Application Publication
(10) Pub. No.: US 2024/0326583 A1
(43) Pub. Date: Oct. 3, 2024

(54) FOUR WHEEL DRIVE SPINDLE LIFT

(71) Applicant: 74 Weld Inc., El Cajon, CA (US)

(72) Inventor: Quinn PULTZ, Encinitas, CA (US)

(21) Appl. No.: 18/622,514

(22) Filed: Mar. 29, 2024

Related U.S. Application Data
(60) Provisional application No. 63/455,908, filed on Mar. 30, 2023.

(51) Int. Cl. B60K 17/04; B62D 7/18; F16H 1/20; F16H 57/02; F16H 57/021; G01P 3/44

(52) U.S. Cl. CPC B60K 17/043; B62D 7/18; F16H 1/20; F16H 57/021; F16H 2057/02052; G01P 3/44

(57) ABSTRACT

A spindle lift assembly has an input gear linked to the axle shaft for rotating around a first rotational axis and an output gear positioned within a second lower rotational axis with a 1:1 gear ratio that converts rotation of the input gear to rotation of the output gear without reduction. A knuckle/upright within the assembly provides lift for increasing ground clearance of the vehicle axle. A wheel speed sensor may be integrated into the assembly.

### RELATED APPLICATIONS

This application claims the benefit of the priority of Provisional Application No. 63/455,908, filed Mar. 30, 2023, which is incorporated herein by reference in its entirety.

### FIELD OF THE INVENTION

The present invention relates to spindle lift for increasing the ground clearance of the axles of a four wheel drive vehicle.

### BACKGROUND

On vehicles equipped with a solid axle, the lowest point is the differential yoke. With four-wheel drive vehicles, the first modification many drivers wish to make is to install larger tires, which will provide improved grip off-road with the correct tread pattern for the terrain to be driven. One of the primary reasons for installing larger tires is that they raise the height of the differential yoke.

Portal axles are modifications that have been in use for decades to allow a vehicle to accommodate larger tires by reducing the gearing at each wheel. Portal axles may also be used to raise the differential yoke, lifting the vehicle, and providing increased ground clearance. The term “portal axle” has always carried the implication that it contains some form of gear reduction at each wheel to lower the final drive ratio, typically ranging between 1.2:1 to 2.0:1 gear reduction. Rather than running through a bearing and on to the hub, the axle connects to a gearbox, i.e., the “portal” or “portal box”, with a housing enclosing a drive gear, two idler gears, and a large driven gear that directs drive down to the wheel hubs, which are usually several inches lower than the case. With this assembly, the hubs can be mounted lower, increasing the ground clearance of the axle. Going deeper than 2:1 is difficult as the input pinion gear becomes so small it lacks the strength required to transmit torque without risking failure. Regardless of what ratio options are available, every portal that has been mass produced has always included a gear reduction.

There are several challenges to trying to lift or lower an independent suspension four wheel drive vehicle. Since by nature an independent suspension is connected directly to the chassis via a pivot point, as the suspension is lifted, the angle from the chassis to the wheel end increases. Power is typically applied to the wheel through a constant velocity (CV) shaft assembly. There are limits to the angles at which a CV shaft can operate. In a two wheel drive application, this rarely presents a problem because power is not transferred to the wheel end—lifting a non-driven independent suspension is commonly done by “a spindle lift.” A spindle lift effectively relocates the factory wheel hub either up to down to achieve the effect of either lifting or lowering the vehicle without changing the angle of the suspension in relation to the chassis. This is not possible with a four wheel drive vehicle without using a portal. However, there are situations in which alteration of the final drivetrain gear ratio may be undesirable. For example, if a user has already modified the gear ratio in the differential to achieve an optimal ratio, further reduction of the gear ratio in order to increase lift could interfere with the torque transmission, and/or lead to premature gear failure.

Accordingly, the need remains for a cost-effective approach to lifting a four wheel drive vehicle that is applicable to most vehicles, easy to install, and requires less maintenance. The present invention is directed to such an approach.

### BRIEF SUMMARY

The inventive four gear portal can be used to lift vehicles with independent suspensions as well as solid axles. The four gear portal introduces no gear reduction by using upper and lower drive gears that have matching tooth counts, so that the gear ratio is 1:1 and the input speed matches the output speed. The benefit of a non-reduction portal can be seen in both independent suspensions as well as solid axle applications. In a solid axle vehicle such as a JEEP WRANGLER®, the 1:1 non-reduction portal would allow a user to run them only on one axle of the vehicle to lift just that one axle. The key is that the non-reduction portal does not alter the final drivetrain gear ratio.

In many vehicles, the OEM uses a wheel speed sensor which is commonly integrated into the unit bearing wheel hub. The inventive approach takes the existing unit bearings and integrates them into a universal portal box, giving it a modular application. The upright/backer/knuckle will be application-specific, however, but an important feature is the incorporation of a common unit bearing into a modular portal platform that will facilitate lifting of a wide range of four wheel drive vehicles without altering the drivetrain gear ratio.

The bolt-on portal is designed to adapt to either OEM or aftermarket axles, as well as to independent suspensions, to provide additional ground clearance while retaining all necessary OEM sensors though the integration of the OEM compatible unit bearing. In some embodiments, the OEM style unit bearing also allows the user the option of running either a full-time drive slug or a lockable style wheel hub which can allow the front unit bearing to spin independent of the portal gear box, allowing for better fuel economy and less wear on the axle components.

The present invention is directed to an improved portal design that facilitates installation and subsequent access and serviceability through the integration of a unit bearing into the portal assembly. The upper input shaft of the inventive portal is also retained in a way that allows the user to easily remove the stub shaft without taking apart the portal.

Details of the construction of the inventive spindle lift are generally the same as those disclosed for a four gear portal in U.S. application Ser. No. 17/723,268, published as Patent Publication No. 2022/0332185, which is incorporated herein by reference. The key difference lies in the use of a 1:1 gear ratio for the upper (drive) and lower (driven) gears, so that the input speed matches the output speed. Importantly, this is a non-reduction portal.

The portal design can be used in either a solid axle application or in an independent suspension. Power is input into the upper (drive) gear, drives a pair of idler gears, which in turn drive a lower (driven) output gear. The 4-gear portal design includes an upper gear, two idler gears, and a lower driven gear. The upper gear is supported by a bearing on either side of the gear. The gear is splined to accept an axle shaft through which power is input into the portal box. This upper gear transmits power through a pair of idler gears. The idler gears are stabilized by needle bearings which are nested inside the hollow gear. This reduces weight and the loose needle design allows the idlers to accommodate heavy radial loads. The idler gears transfer power to a lower gear. The lower gear is splined to accept an axle shaft connecting the gear to the unit bearing via either a drive slug or a selectable locking hub. The lower gear can also have an integrated axle shaft which directly drives a unit bearing.

In an independent suspension application, the inventive design lifts the input CV, allowing the vehicle to reduce CV angle. This can translate to greater ground clearance, but only if the lower suspension point is optimized. A major benefit in the case of independent suspension is the ability to reduce the angle of the CV at static “ride height.” Reducing the CV angle at ride height provides the potential for greater wheel travel and steering.

In one aspect, portal assembly for a vehicle axle having a rotatable axle shaft includes: a housing configured for attachment to the vehicle axle; a gear assembly disposed within the housing, the gear assembly including an input gear linked to the axle shaft, the input gear configured to rotate around a first rotational axis in response to a rotational force from the axle shaft; an output gear disposed along a second rotational axis spaced at a distance lower than the first rotational axis, the output gear configured to convert rotation of the input gear to rotation of the output gear, wherein the output gear and the input gear have matching tooth counts and diameters so that there is a 1:1 gear ratio; a pair of idler gears configured to transfer rotational force from the input gear to the output gear; an output axle shaft configured to be driven by the output gear, the output axle shaft extending through an opening in the housing; and a unit bearing attached to the housing and configured to be driven by the output axle shaft, the unit bearing having fasteners extending therefrom for attachment to a wheel hub.

In some embodiments, the output gear is in direct contact with the input gear. The vehicle axle may be a steering axle where the housing includes a knuckle portion configured for replacement of an existing knuckle portion on the axle. In some embodiments, the axle shaft is linked to the upper gear by means of a u-joint or constant velocity (CV) joint. The assembly may further include a wheel speed sensor configured to penetrate the portal assembly. A reluctor ring or magnetic encoder readable by the wheel speed sensor may be disposed on one of an idler gear, the input gear and the output gear.

In another aspect, a portal gear assembly includes: an input gear linked to a stub shaft, the input gear configured to rotate around a first rotational axis in response to a rotational force from the stub shaft; an output gear disposed along a second rotational axis spaced at a distance lower than the first rotational axis, the output gear configured to convert a rotational force of the input gear to rotation of the output gear at a 1:1 ratio; a pair of idler gears configured to transfer the rotational force from the input gear to the output gear; an output axle shaft configured to be driven by the output gear; and a unit bearing configured to be linked to and driven by the output axle shaft, the unit bearing having fasteners extending therefrom for attachment to a wheel hub.

The output gear may be integrally formed with the output axle shaft. The vehicle axle may be a steering axle where the housing includes a knuckle portion configured for replacement of an existing knuckle portion on the axle. In some embodiments, the axle shaft is linked to the upper gear by means of a u-joint or constant velocity (CV) joint. The assembly may further include a wheel speed sensor configured to penetrate the portal assembly. A reluctor ring or magnetic encoder readable by the wheel speed sensor may be disposed on one of an idler gear, the input gear and the output gear.

In still another aspect, a portal assembly, includes a housing having a proximal side configured for attachment to a vehicle axle with a stub shaft extending through a proximal opening and a distal side having a distal opening; a gear assembly disposed within the housing and configured to transfer torque from the stub shaft on a first rotational axis to an output axle shaft on a second rotational axis at a 1:1 ratio, wherein the second rotational axis is disposed at a lift spacing below the first rotational axis; and a unit bearing attached to the distal side and configured to be driven by the output axle shaft extending through the distal opening, the unit bearing configured for attachment to a wheel hub.

The gear assembly may include an upper gear disposed along the first rotational axis and a lower gear disposed along the second rotational axis, the upper gear and the lower gear having matching tooth counts and diameters. In some embodiments, a pair of idler gears may be configured to transfer rotational force from the input gear to the output gear. The output gear may be integrally formed with the output axle shaft. The vehicle axle may be a steering axle where the housing includes a knuckle portion configured for replacement of an existing knuckle portion on the axle. In some embodiments, the axle shaft is linked to the upper gear by means of a u-joint or constant velocity (CV) joint. The assembly may further include a wheel speed sensor configured to penetrate the portal assembly. A reluctor ring or magnetic encoder readable by the wheel speed sensor may be disposed on one of an idler gear, the input gear and the output gear.

### BRIEF DESCRIPTION OF THE DRAWINGS

FIG. 1A is a perspective partially exploded view of a 4-gear portal according to an embodiment of the invention connected to a steering axle; FIG. 1B is a side view of a 4-gear portal connected to a non-steering axle.

FIGS. 2A-2C are perspective views of exemplary 4-gear portals for a steering axle according to embodiments of the invention; FIG. 2B is a perspective view of the portal gears with the portal box removed; FIG. 2C is a perspective view of an alternative configuration of the upright/backer and portal box for a 4-gear portal; FIG. 2D is a perspective view of a 4-gear portal for a non-steering axle.

FIG. 3A is a front plan view of an embodiment of a 4-gear portal; FIG. 3B is a cross-sectional view taken along line A-A of FIG. 3A, which cuts through the upper and lower gears; FIG. 3C is a cross-sectional view taken along line B-B of FIG. 3A, which cuts through the idler gears.

FIGS. 4A-4C are front, side and perspective views, respectively, of an embodiment of a 4-gear portal assembly and unit bearing.

FIGS. 5A-5G show a wheel speed sensor assembly according to an embodiment of the inventive portal where FIG. 5A is a side plan view of a hub and portal assembly; FIG. 5B is a cross-sectional view taken along line A-A of FIG. 5A; FIG. 5C is a cross-sectional view of detail B of FIG. 5B showing wheel speed read inside the hub assembly; FIG. 5D is a cross-sectional view of detail C of FIG. 5B showing wheel speed read between the hub assembly and lower gear; FIG. 5E is a cross-sectional view of detail D of FIG. 5B showing wheel speed read from the lower gear; FIG. 5F is a cross-sectional view of detail E of FIG. 5B showing wheel speed read from upper gear; and FIG. 5G is a cross-sectional view taken along line F-F of FIG. 5A showing wheel speed read from idler gear.

FIGS. 6A-6B show an embodiment of a wheel speed sensor mounted upright, where FIG. 6A is a side plan view of a hub and portal assembly; and FIG. 6B is a cross-sectional view taken along line G-G of FIG. 6A.

### DETAILED DESCRIPTION OF EMBODIMENTS

The reference numerals and their corresponding numbers used in the drawings and the detailed description are listed in Table 1 below.

TABLE 1

| Ref. # | Description |
|---|---|
| 1 | Lower (driven) gear |
| 2 | Driven gear idler |
| 3 | Upper (drive) gear |
| 4 | Bearing, idler |
| 5 | Unit bearing, bearing pack |
| 6 | Unit bearing, output flange |
| 7 | Bearing lower |
| 8 | Bearing upper |
| 9 | Input shaft |
| 10 | Nut, input shaft |
| 11 | Hub cap |
| 12 | Portal box |
| 13 | Knuckle/upright |
| 14 | Axle |
| 15 | Differential |
| 16 | Wheel hub |
| 17 | Bolts |
| 18 | Encoder |
| 19 | Sensor |

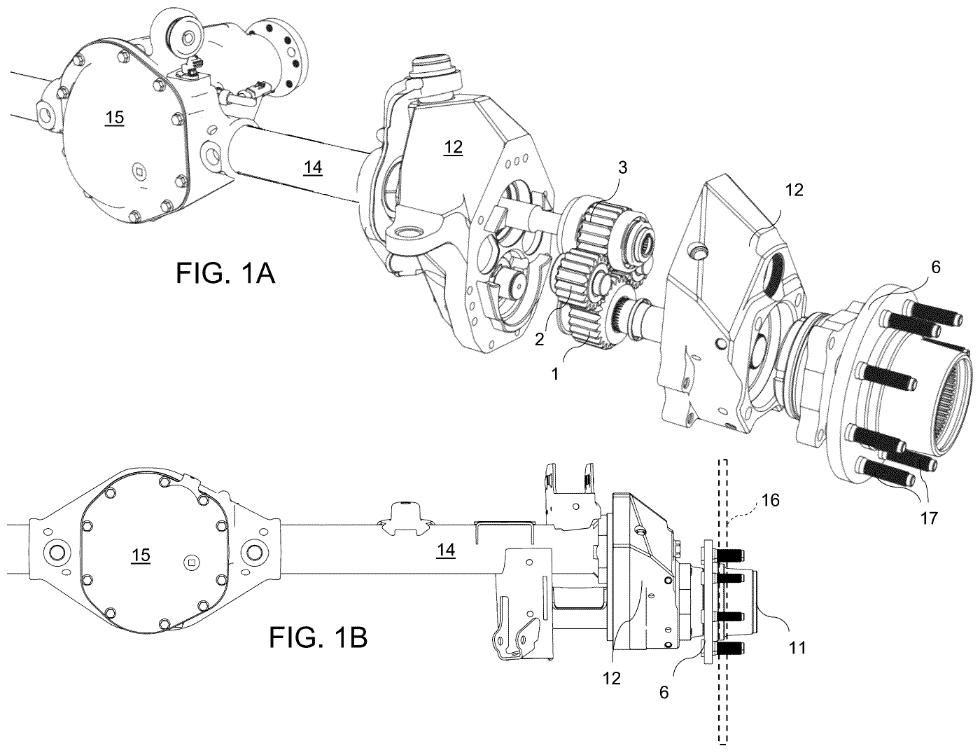

In any portal application, the functionality of the portal remains constant. Referring to FIGS. 1A and 1B, when external power applied to axle 14 via differential 15, that power is transferred though an input gear 3, to a pair of idler gears 2, to a lower driven gear 1, which, in turn, transfers power a wheel hub (indicated via dashed lines 16 in FIG. 1B), which is attached via bolts 17. The tooth count and the gear dimensions of the upper and lower gears are selected to provide a 1:1 transfer, i.e., no gear reduction at the final gear. A portal can come in several configurations. Most common is a steering solid axle, as in FIG. 1A, where the portal bolts to an inner knuckle of the axle and replaces the traditional outer knuckle assembly used in steering applications. A second would be a non-steering solid axle configuration, such as the example shown in FIG. 1B. A third would be an independent steering application. A fourth would be an independent non steering application. These and other variations would be readily apparent to one of skill in the art and are, therefore, not separately illustrated or described.

In all applications, a portal lifts the centerline of the axle to provide additional ground clearance. On a solid axle, the portal lifts the vehicle a predetermined distance that is equal to the distance between center of the upper portal gear to the center of the lower portal gear. On an independent suspension, a portal does not necessarily lift the vehicle. In such applications, the portal allows the user to lift the CV input shaft and place the lower suspension point at a height that would not be achievable on a traditional four wheel drive application.

Power from an engine is most commonly transferred through a transmission to a transfer case (in four wheel drive applications) where the front and rear differentials 15 receive input and are powered by the respective drive shafts. The portal axle is mated to the differentials. In a solid axle steering application, the portal replaces the conventional knuckle, as shown in FIG. 1A. In a non-steering application (e.g., FIG. 1B), the portal utilizes what is commonly referred to as a “semi-float bearing cup” and replaces the semi-float axle shaft. The portal bolts to the semi float bearing cup and converts a traditionally semi-float application into a full float axle.

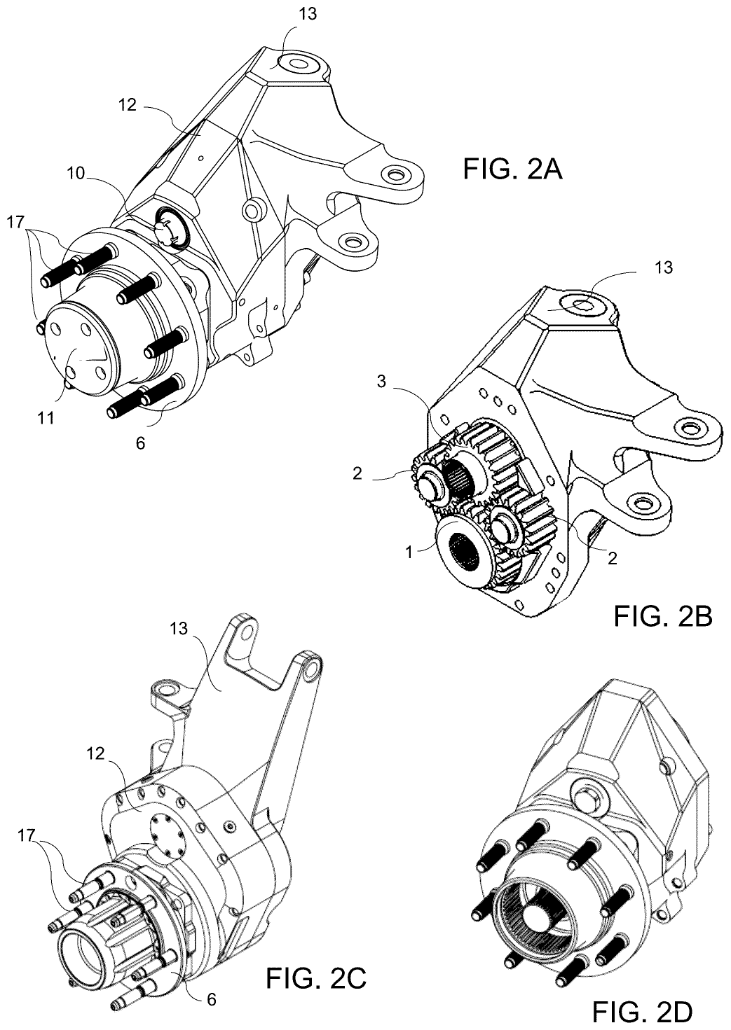

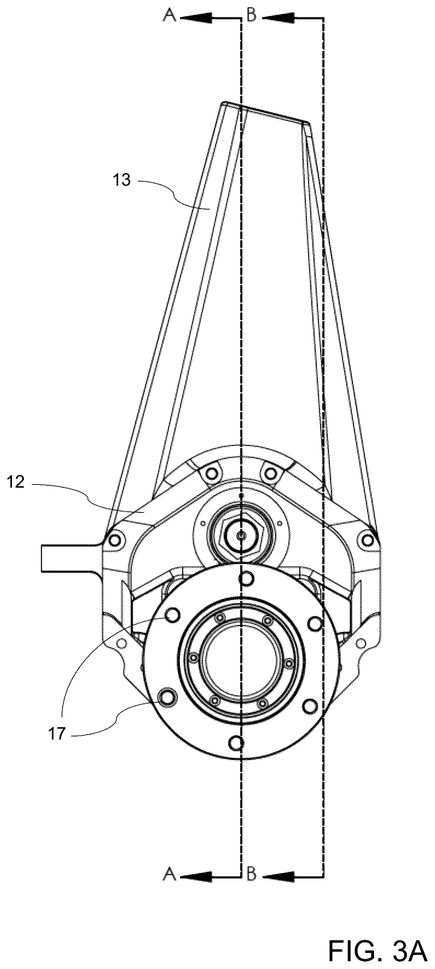

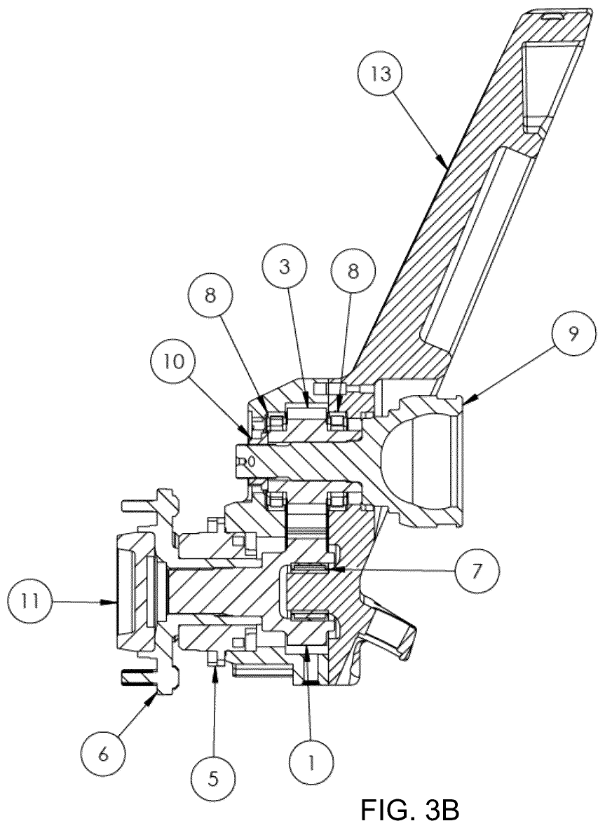

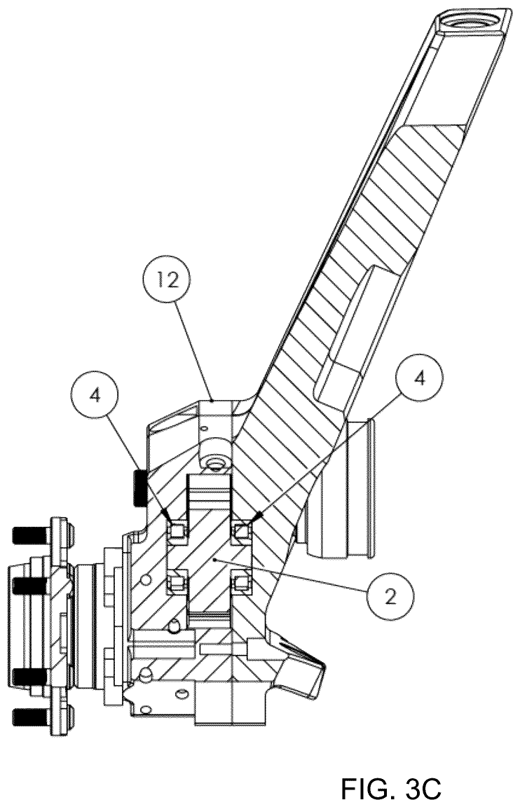

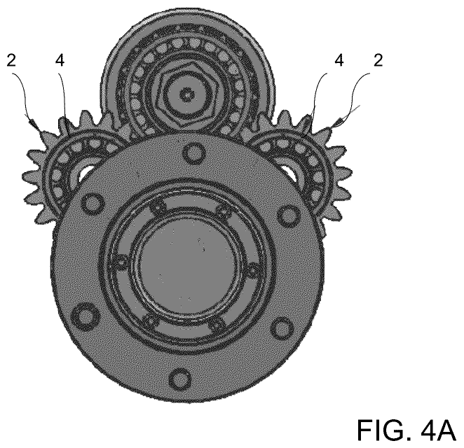

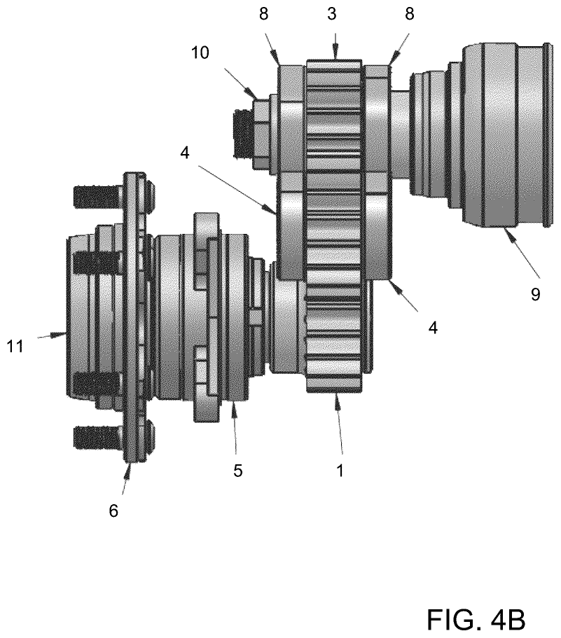

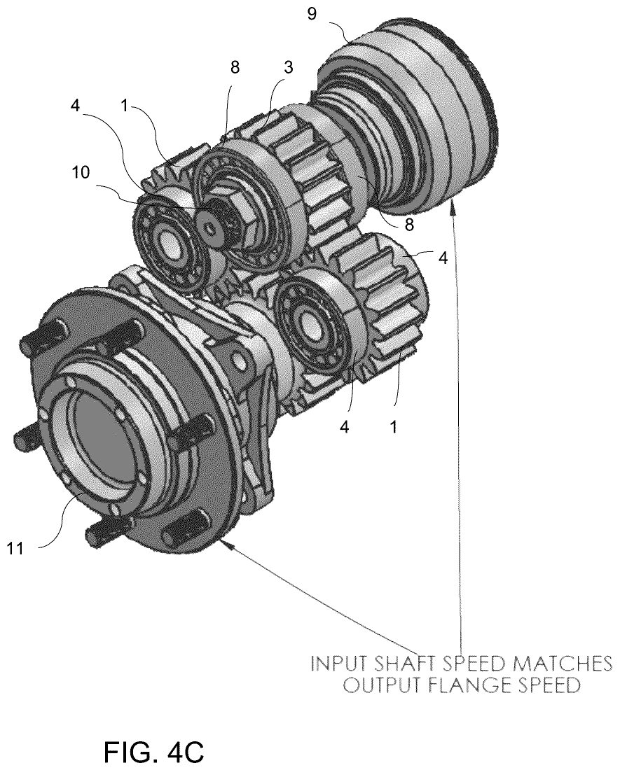

FIGS. 2A-2D illustrate examples of 4-gear portals configured for attachment to different OEM axle configurations, where FIGS. 2A-2C depict a variety of examples of portals for attachment to a steering axle and FIG. 2D shows an example of a portal for a non-steering axle. This latter configuration differs from the other versions only in the exterior mounting features used for attachment of the housing, i.e., the portal box 12, to the axle. The internal operations and general principles are common across all configurations as will be detailed with reference to FIGS. 3A-4C below.

Referring to FIGS. 3A-4C, in a solid axle application of a 4-gear portal, power is first input into the upper (drive) portal gear 3. An axle shaft comes from the differential and is mated to the portal either directly to the splines of the upper gear by means of a u-joint or constant velocity (CV) joint which is used on steering applications. The upper portal gear 3 is stabilized by upper inner bearings 8. These two bearings are nested into the portal box 12. The upper gear 3 is sealed on the inner side by an upper inner gear seal and sealed on the outer side by the upper stub retainer and sealing nut 10. This allows for the input axle to be installed once the portal is fully assembled.

As the upper portal gear 3 turns, it drives a pair of idler gears 2. These idler gears 2 are hollow and feature needle bearings to control all radial loads. The idler gears 2 are stabilized against axial loads by a pair of thrust bearings 4. Two idler gears 2 are used to increase the surface contact and overall strength of the unit. The idler gears 2 transfer rotational force from upper drive gear 3 to drive lower driven gear 1 which then drives lower axle shaft 9 and the wheel hub 16 via unit bearing 5.

In some embodiments, the inventive approach provides the ability to read wheel speed at any of a number of different locations within a portal, thus providing for compatible integration with different OEMs. There are two main variations: (1) wheel speed can be read in the middle of the bearing pack (typical for many OE); or (2) the wheel speed sensor can penetrate the portal box in some manner.

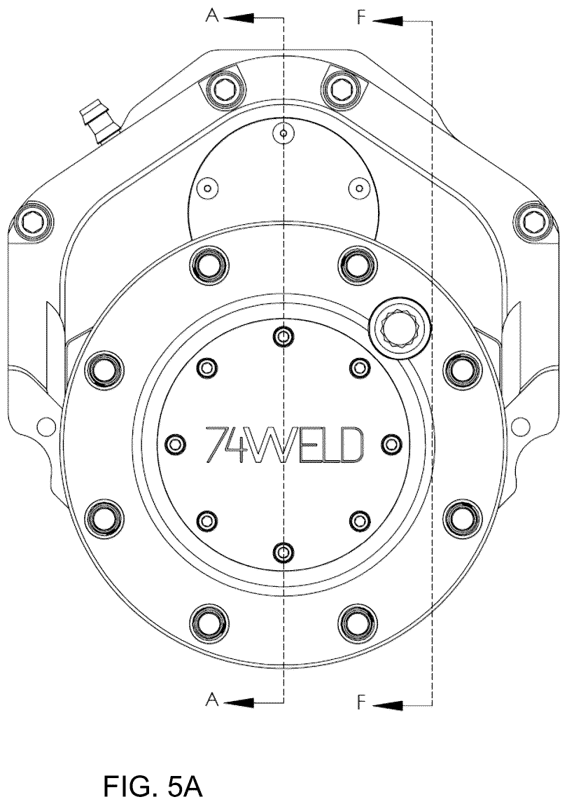

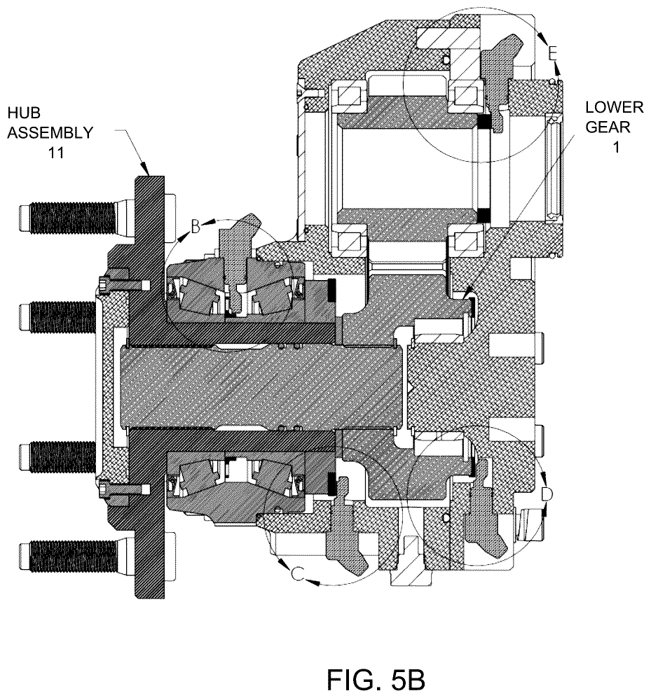

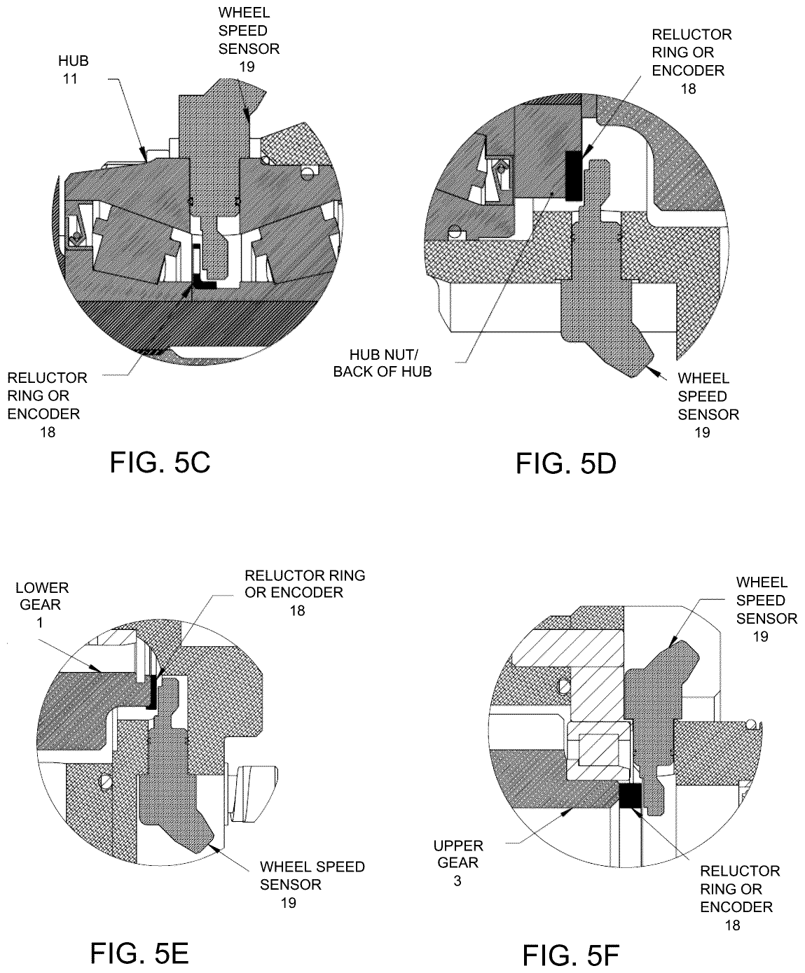

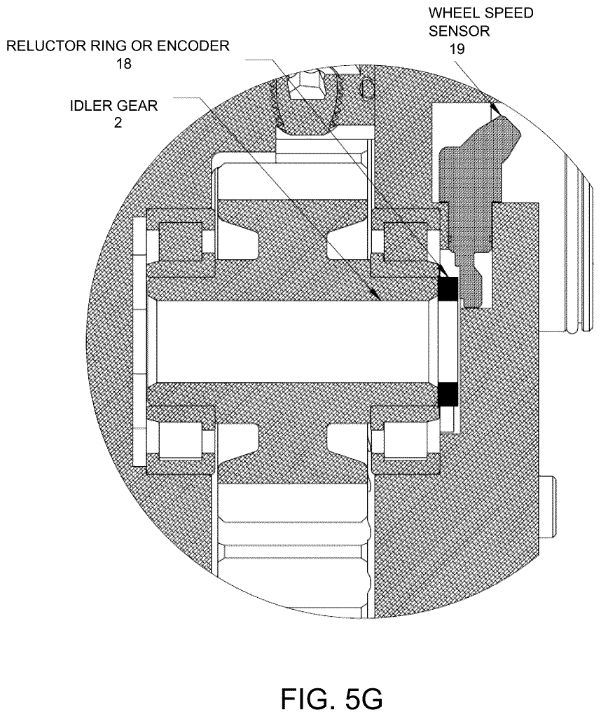

Integration of an electronic wheel speed sensor is an important element of the functionality and utility of the portal in all vehicles that run ABS systems. The sensor reads either a tone ring or magnetic encoder to determine wheel speed. This data is used for many systems within the vehicle however the main priority lies in maintaining its functionality in the portal application so that all systems function as intended by the OEM. To do this we must integrate a wheel speed sensor into the portal. This can be easily done in several different locations. Because the wheel speed sensor wants to read final wheel speed at the hub, if there is a reduction in the portal box it is best to pick up the wheel speed after the final gear reduction. Referring to FIGS. 5A-5G, this can be done in any of three spots as outlined in detail C, detail D, and detail E of FIG. 5B, which correspond to FIGS. 5D-5F, respectively. Detail B (FIG. 5C) shows the typical location of a tone ring in an OE application. The tone ring is integrated into the hub and the wheel speed sensor 19 plugs into the side of the bearing pack and reads the tone ring. This approach has been employed by many manufacturers for decades. This was a key motivation for designing a unit bearing into some embodiments of the inventive portal applications, i.e., for case of ABS integration.

Detail C (FIG. 5D) shows how a typical magnetic encoder 18 is read in this specific portal application. The magnetic encoder is typically located on the back of the bearing pack and is integrated into the dust seal by the bearing manufacturer. Where the inventive approach differs greatly from anything previously done is how we locate and hold the sensor. In this implementation, the sensor is not held by the factory upright, but instead the sensor is integrated into the portal box. The portal box holds the sensor in relation to the tone or magnetic encoder which is located on the back side of the wheel hub. In doing so, it enables ABS compatibility in a portal application.

Detail D (FIG. 5E) shows a different location to mount the wheel speed magnetic encoder 18. In this application, the magnetic encoder 18 or tone ring is located on the back of the gear by either a press fit or by a chemical adhesive. In a tone ring application, the tooth profile could also be physically machined into the gear making it permanently integrated into the unit. The wheel speed sensor is then positioned into the portal box such that it can read the tone or magnetic pulse at the back of the gear.

Detail E (FIG. 5F) shows a wheel speed sensor that reads either a tone ring or magnetic encoder 18 off of the idler gear. This location could be preferable in certain applications but will require a different tooth count or magnetic pair in applications that run a final gear reduction as this idler gear will spin at a different rate than the final driven gear in a gear reduction application. In a non-reduction application, this could be a preferable spot to integrate a wheel speed sensor. The sensor is shown reading the wheel speed on the back side of the gear but it could alternatively be moved to the opposite side of the gear and have the sensor and tone ring/magnetic encoder 18 located on the other side of the gear.

Detail F (FIG. 5G) shows a wheel speed sensor that reads either a tone ring or magnetic encoder 18 off of the input gear of the portal. The placement of the sensor and tone ring/magnetic encoder could be on either side of the gear in this application. In either location, the wheel speed sensor 19 would need to penetrate the portal box in order to read either a tone ring or magnetic encoder.

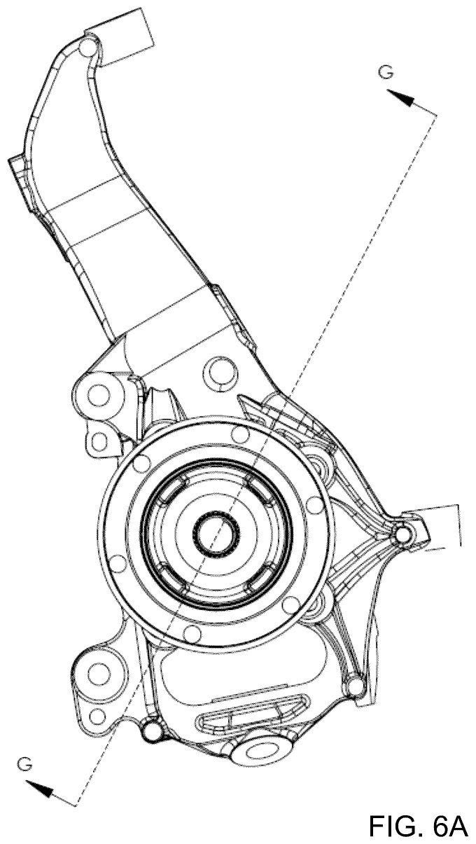

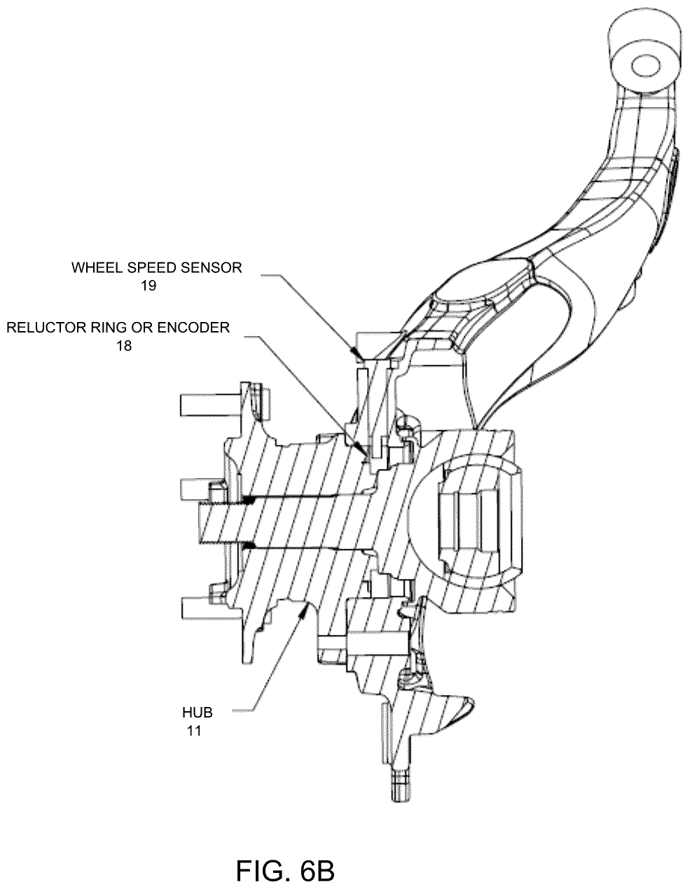

FIGS. 6A-6B show an exemplary embodiment of a portal with a wheel speed sensor mounted to a factory upright. FIG. 6A is a side plan view of the upright with a hub and portal assembly with the encoder incorporated into the portal. FIG. 6B is a cross-sectional view taken along line G-G of FIG. 6A.

The foregoing description and accompanying drawings provide illustrative examples of portal boxes that incorporate the principles of the invention. These examples are not intended to be limiting, and it will be readily apparent to those in the art that different permutations and combinations of the components features described herein may be made that still fall within the scope of the invention.

1. A portal assembly for a vehicle axle having a rotatable axle shaft, the portal assembly comprising:
a housing configured for attachment to the vehicle axle;
a gear assembly disposed within the housing, the gear assembly comprising:
an input gear linked to the axle shaft, the input gear configured to rotate around a first rotational axis in response to a rotational force from the axle shaft;
an output gear disposed along a second rotational axis spaced at a distance lower than the first rotational axis, the output gear configured to convert rotation of the input gear to rotation of the output gear, wherein the output gear and the input gear have matching tooth counts and diameters so that there is a 1:1 gear ratio;
a pair of idler gears configured to transfer rotational force from the input gear to the output gear;
an output axle shaft configured to be driven by the output gear, the output axle shaft extending through an opening in the housing; and
a unit bearing attached to the housing and configured to be driven by the output axle shaft, the unit bearing having fasteners extending therefrom for attachment to a wheel hub.

2. The portal assembly of claim 1, wherein the output gear is in direct contact with the input gear.

3. The portal assembly of claim 1, wherein the vehicle axle comprises a steering axle and the housing comprises a knuckle portion configured for replacement of an existing knuckle portion on the axle.

4. The portal assembly of claim 1, wherein the axle shaft is linked to the upper gear by means of a u-joint or constant velocity (CV) joint.

5. The portal assembly of claim 1, further comprising a wheel speed sensor configured to penetrate the portal assembly.

6. The portal assembly of claim 5, wherein a reluctor ring or magnetic encoder readable by the wheel speed sensor is disposed on one of an idler gear, the input gear and the output gear.

7. A portal gear assembly, comprising:
an input gear linked to a stub shaft, the input gear configured to rotate around a first rotational axis in response to a rotational force from the stub shaft;
an output gear disposed along a second rotational axis spaced at a distance lower than the first rotational axis, the output gear configured to convert a rotational force of the input gear to rotation of the output gear at a 1:1 ratio;
a pair of idler gears configured to transfer the rotational force from the input gear to the output gear;
an output axle shaft configured to be driven by the output gear; and
a unit bearing configured to be linked to and driven by the output axle shaft, the unit bearing having fasteners extending therefrom for attachment to a wheel hub.

8. The portal gear assembly of claim 7, wherein the output gear is integrally formed with the output axle shaft.

9. The portal gear assembly of claim 7, wherein a vehicle axle to which the stub shaft is mounted comprises a steering axle and a portal housing comprises a knuckle portion configured for replacement of an existing knuckle portion on the axle.

10. The portal gear assembly of claim 7, wherein the stub shaft is linked to the upper gear by means of a u-joint or constant velocity (CV) joint.

11. The portal assembly of claim 7, further comprising a wheel speed sensor configured to penetrate the portal assembly.

12. The portal assembly of claim 11, wherein a reluctor ring or magnetic encoder readable by the wheel speed sensor is disposed on one of an idler gear, the input gear and the output gear.

13. A portal assembly, comprising:
a housing having a proximal side configured for attachment to a vehicle axle with a stub shaft extending through a proximal opening and a distal side having a distal opening;
a gear assembly disposed within the housing and configured to transfer torque from the stub shaft on a first rotational axis to an output axle shaft on a second rotational axis at a 1:1 ratio, wherein the second rotational axis is disposed at a lift spacing below the first rotational axis; and
a unit bearing attached to the distal side and configured to be driven by the output axle shaft extending through the distal opening, the unit bearing configured for attachment to a wheel hub.

14. The portal assembly of claim 13, wherein the gear assembly comprises an upper gear disposed along the first rotational axis and a lower gear disposed along the second rotational axis, the upper gear and the lower gear having matching tooth counts and diameters.

15. The portal assembly of claim 14, further comprising a pair of idler gears configured to transfer rotational force from the input gear to the output gear.

16. The portal assembly of claim 14, wherein the output gear is integrally formed with the output axle shaft.

17. The portal assembly of claim 13, wherein the vehicle axle comprises a steering axle and the proximal side comprises a knuckle portion configured for replacement of an existing knuckle portion on the vehicle axle.

18. The portal assembly of claim 13, further comprising a wheel speed sensor configured to penetrate the portal assembly.

19. The portal assembly of claim 18, wherein a reluctor ring or magnetic encoder readable by the wheel speed sensor is disposed on one of an idler gear, the input gear and the output gear.
